(19) United States
(12) Patent Application Publication
(10) Pub. No.: US 2004/0148285 A1
(43) Pub. Date: Jul. 29, 2004

(54) System for distributing form contracts and monitoring usage thereof

(76) Inventors: Rhynette N. Hurd, Germantown, TN (US); Marianne A. Duvall, Olive Branch, MS (US)

Correspondence Address: RICHARD C. STEWART, II, INTERNATIONAL PAPER COMPANY, 1422 LONG MEADOW ROAD, TUXEDO, NY, 10987, US

(21) Appl. No.: 10/700,931

(22) Filed: Nov. 3, 2003

Related U.S. Application Data
(60) Provisional application No. 60/423,047, filed on Nov. 1, 2002.

(51) Int. Cl. G06F 17/30

(52) U.S. Cl. 707/9

(57) ABSTRACT

The present invention comprises a system for distributing form contracts for use by system users, for monitoring their usage, and for enabling system administrators, managers, and executives to assess the extent of such usage and to identify patterns of usage, or non-usage. The system includes a plurality of form contracts which are stored in a database that is accessible, via a communication network, to system users who are, generally, non-attorneys. The system detects users' access of the system, opening of form contracts for review, and launching (or downloading) of form contracts. Upon detecting the occurrence of such actions, the system generates performance metrics data which is stored in the database for subsequent retrieval and viewing according to a plurality of selectable views.

### CROSS REFERENCE TO RELATED APPLICATION

This application is based upon and claims the priority of U.S. Provisional Patent Application Serial No. 60/423,047, filed Nov. 1, 2002, which is incorporated herein by reference.

### FIELD OF THE INVENTION

The present invention relates, generally, to the field of form contract management, distribution and usage monitoring and, more specifically, to systems for distributing form contracts and for generating performance metrics associated with the usage of such form contracts.

### BACKGROUND OF THE INVENTION

In the business world, non-attorney corporate business personnel must often provide contract documents to third parties to govern the purchase or exchange of goods, services, and other items. However, because the corporate business personnel are not attorneys, they may not have the requisite knowledge and/or skills to prepare contract documents, to revise contract documents, or to negotiate the provisions of such contract documents. As a consequence, when corporate business personnel perform such tasks, they may do so inefficiently, ineffectively, and at great business and legal peril to their corporations.

A potential solution to this problem may be to prepare form contract documents and to place them in a public folder on a computer system so that corporate business personnel may freely access the form contracts and utilize them whenever the need arises for a contract document. Unfortunately, this solution does not address the concern that the non-attorney corporate business personnel may not have the training or expertise to revise and negotiate the contract documents. Also, even though such form contract documents may be available electronically, there can be no assurance that the corporate business personnel will actually use the documents, thereby making the economic costs associated with this potential solution difficult to justify.

Therefore, there exists in the industry, a need for enabling non-attorney corporate business personnel to provide contract documents to third parties which resolves the above-described difficulties and shortcomings, and other related and unrelated difficulties or shortcomings.

### SUMMARY OF THE INVENTION

Briefly described, the present invention comprises a form contract distribution and performance metrics monitoring system, including apparatuses and methods, for distributing form contracts for use by system users (including, but not limited to, non-attorney corporate business personnel), for monitoring usage of the form contracts, and for enabling system administrators, executives, and managers to assess the extent of such usage and to identify patterns of usage, or non-usage. Preferably, the system includes a plurality of form contracts which are stored in a database that is accessible, via a communication network, to system users. The system, also preferably, detects the users' access of the system, the opening of form contracts for review, and the launching (or downloading) of form contracts for use. Upon detecting the occurrence of such actions, the system generates performance metrics data which is, preferably, stored in the database for subsequent retrieval and viewing according to a plurality of selectable views.

Business executives and management personnel may utilize such usage patterns to justify expenses associated with the licensing, installation, configuration, training, and on-going maintenance of the form contract distribution and performance metrics monitoring system. Such usage patterns may also be utilized by business executives and management personnel (including, system administrators) to track the accessing of the system by system users, to identify particular form contracts and groups of form contracts which are being often utilized or underutilized by system users, to determine which user departments or groups are more actively using form contracts, and to ascertain whether the system's form contracts are merely being viewed or actually used by system users. Business executives and management personnel, based on such usage patterns, may also decide where encouragement is required to improve usage of the system.

Therefore, an object of the present invention is to provide form contracts for use by business personnel.

Another object of the present invention is to assist business personnel in the alteration and negotiation of contract documents.

Still another object of the present invention is to monitor the usage and types of usage of form contract documents.

Still another object of the present invention is to provide business executives and managers with the performance metrics data necessary to justify system implementation or expansion.

Other objects, features, and advantages of the present invention will become apparent upon reading and understanding the present specification.

### BRIEF DESCRIPTION OF THE DRAWINGS

FIG. 1 displays a pictorial representation of an initial user interface screen, or home page, of a form contract distribution and performance metrics monitoring system according to a preferred embodiment of the present invention.

FIG. 2 displays a pictorial representation of a user interface screen of the system of FIG. 1 displaying a list of the names of the business, or contract, groups for which form contracts are available.

FIG. 3 displays a pictorial representation of a user interface screen of the system of FIG. 1 displaying a list of the form contracts which are available for a selected business, or contract, group.

FIG. 4 displays a block diagram representation of the computer hardware and data communication of the system of FIG. 1.

FIG. 5 displays a block diagram representation of the computer software environment of the system of FIG. 1.

FIG. 6 displays a flowchart representation of a method of monitoring and performance metrics data generation of the system of FIG. 1.

FIGS. 7A-7C display a flowchart representation of a method of viewing performance metric data of the system of FIG. 1.

FIG. 8 displays a pictorial representation of a view metrics user interface screen, or pane, of the system of FIG. 1 displaying viewing options selectable by a system administrator which enable the review of performance metrics data.

FIG. 9 displays a pictorial representation of a view metrics by contract user interface screen, or pane, of the system of FIG. 1 displaying performance metrics data arranged by form contract.

FIG. 10 displays a pictorial representation of a view metrics by contract group user interface screen, or pane, of the system of FIG. 1 displaying performance metrics data arranged by business, or contract, groups.

FIG. 11 displays a pictorial representation of a view metrics by database hits user interface screen, or pane, of the system of FIG. 1 displaying performance metrics data arranged by database.

FIG. 12 displays a pictorial representation of a view metrics by launched contract user interface screen, or pane, of the system of FIG. 1 displaying performance metrics data arranged by launched contract.

FIG. 13 displays a pictorial representation of a view metrics by launched contract group user interface screen, or pane, of the system of FIG. 1 displaying performance metrics data arranged by launched contract group.

FIG. 14 displays a pictorial representation of a view metrics by user department user interface screen, or pane, of the system of FIG. 1 displaying performance metrics data arranged by user department.

FIG. 15 displays a pictorial representation of an admin metrics user interface screen, or pane, of the system of FIG. 1 displaying performance metrics data arranged by user department.

FIG. 16 displays a pictorial representation of a count of contracts user interface screen, or pane, of the system of FIG. 1 displaying a list and count of form contracts present in the system.

FIG. 17 displays a pictorial representation of a list of form contracts user interface screen, or pane, of the system of FIG. 1 displaying a list of form contracts present in the system.

### DETAILED DESCRIPTION OF THE PREFERRED EMBODIMENT

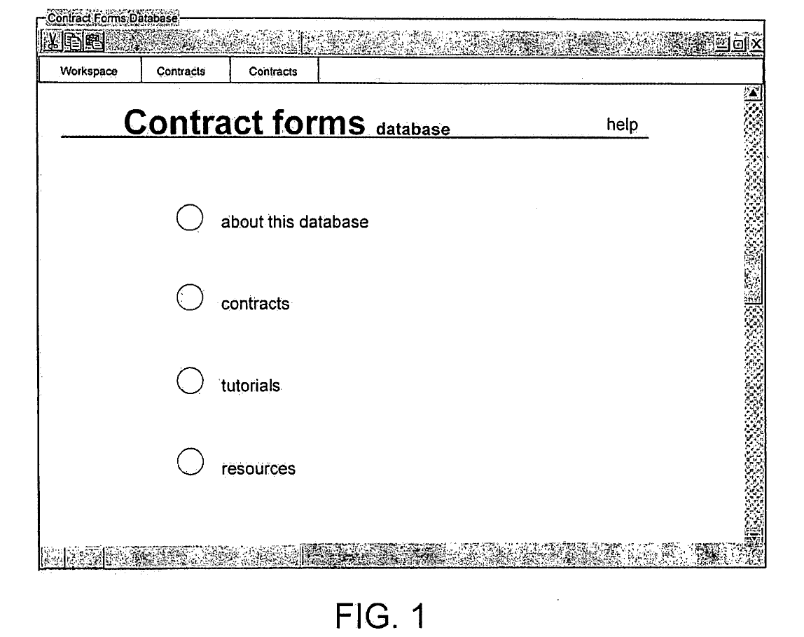

Referring now to the drawings in which like numerals represent similar elements or steps throughout the several views, FIG. 1 displays an initial screen or home page of a form contract distribution and performance metrics monitoring system 100, in accordance with a preferred embodiment, which enables attorneys to build (i.e., create), maintain (i.e., edit or revise as necessary), and manage a database 210 containing form contracts and contract information pertaining to the form contracts (i.e., sometimes referred to herein as “contract profile data”) for use by system users. For each form contract stored in the database 210 (described below), such contract profile data includes, for example and without limitation, a descriptive name uniquely identifying the contract, and a description of the circumstances for which the contract is to be employed; a business group name identifying the business group, unit, or department with which the contract is associated and for whom the contract is, generally, most often used. Each form contract may include: explanations of various provisions which inform a user as to the significance and importance of the respective provisions and of any related nuances; alternative provisions which may be incorporated by a user in an actual, non-form contract in addition to, or in lieu of, various contract provisions; suggested negotiation positions and/or negotiation limits for various contract provisions; and, restrictions on the contract's use (including, but not limited to, situational restrictions which limit the contract's use to particular business situations, and/or restrictions on the users who may use the contract). Generally, the form contract distribution and performance metrics monitoring system 100 allows attorneys (i.e., and/or other legal staff personnel serving as “system administrators”) to create or edit appropriate form contracts using word processing computer software and to then import, or upload, the form contracts to the system's database 210 for storage therein. After importation of a form contract, contract profile data (such as, but not limited to, the information described above) is input and/or edited and stored in the database 210 for subsequent use by the system 100.

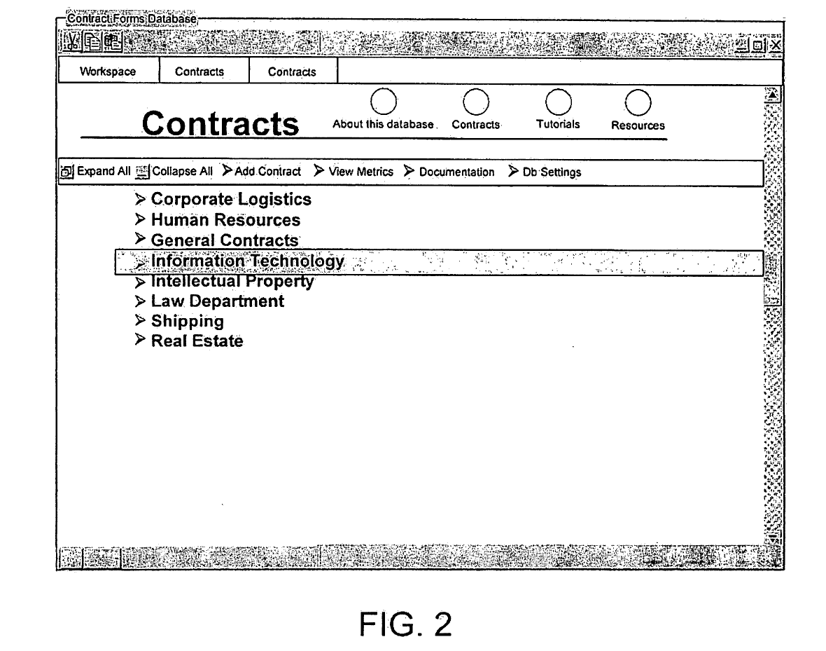

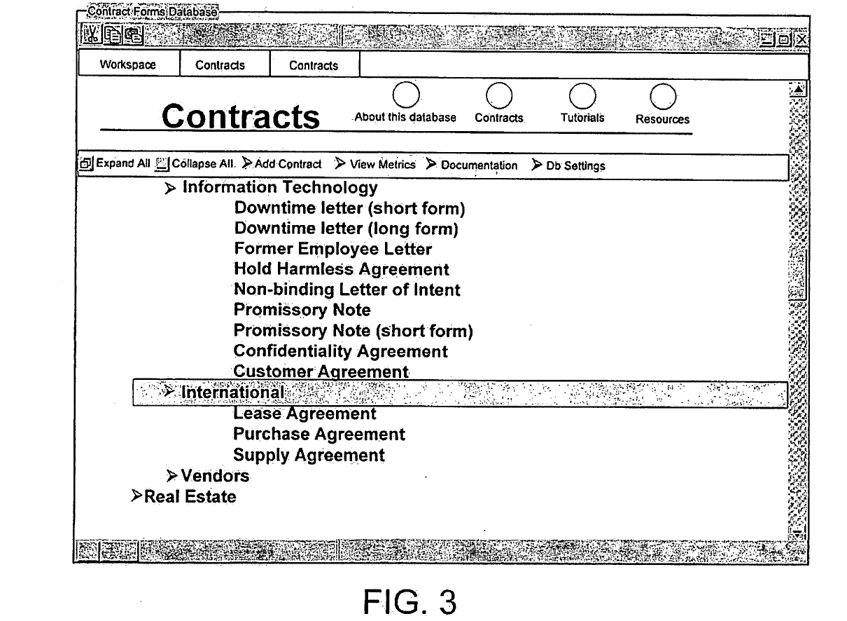

The form contract distribution and performance metrics monitoring system 100 also enables the system's users (e.g., persons having a need to provide a contract to a third party and to negotiate the contract with such party) to: view a list of the names of the business groups, units, or departments for which form contracts are available (see FIG. 2); select a business group, unit, or department from the list of business group, unit, or department names in order to view the form contracts therefor; view a list of the form contracts stored in the database 210 for a selected business group, unit, or department, presented by their descriptive names (see FIG. 3); select a form contract from such a list of form contracts; review the provisions of a selected form contract; receive tutorial information pertaining to usage of a selected form contract (e.g., some or all of the information described above for the selected form contract); and, to launch or download a copy of a selected form contract from the system's database 210 for appropriate editing and use in conjunction with a particular business contracting situation.

For example, if a system user in an information technology department requires a confidentiality/non-disclosure agreement for use with a potential vendor of computer software, the system user accesses the system 100 and selects the information technology department from the list of business groups, units, or departments. Upon being presented with a list of form contracts available for use by users in the information technology department, the system user may select and review particular form contracts and the information associated with them before selecting a form contract for launching or downloading. After downloading a copy of the selected form contract, the system user may then edit the form contract using word processing computer software, as necessary, during negotiation of the contract to reflect the current state of the agreement reached by the parties, while being able to refer back to information in the system's database pertaining to the selected form contract (i.e., including, for example, to information concerning alternative provisions which may be incorporated by the system user in addition to, or in lieu of, various form contract provisions or concerning suggested negotiation positions and/or negotiation limits for various form contract provisions).

The form contract distribution and performance metrics monitoring system 100 also collects performance metrics data which relates to the usage of the system 100 and each form contract stored in the system's database 210. The performance metrics data is collected when a system user accesses the system 100, opens a form contract of the system 100, and launches (or downloads) a form contract for use in a particular business situation. Preferably, the performance metrics data includes, without limitation: counts of the number of times system users access, or hit, the system 100 (i.e., also referred to herein as “database hits”); counts of the number of times system users open each of the system's form contracts (i.e., also referred to herein as “contract hits”); counts of the number of times system users open form contracts associated with each business group, unit, or department (i.e., also referred to herein as “contract group hits”); counts of the number of times system users of each user department open form contracts (i.e., also referred to herein as “user department hits”); counts of the number times system users open form contracts for the current month and year (i.e., also referred to herein as “admin metrics hits”); counts of the number of times system users launch, or download, each of the system's form contracts (i.e., also referred to herein as “launched contract hits”); and counts of the number of times system users launch, or download, form contracts associated with each business group, unit, or department (i.e., also referred to herein as “launched contract group hits”).

The form contract distribution and performance metrics monitoring system 100 and the performance metrics data which it collects and presents, enable system administrators to monitor usage patterns of the system's form contracts. Business executives and management personnel may utilize such usage patterns to justify expenses associated with the licensing, installation, configuration, training, and on-going maintenance of the form contract distribution and performance metrics monitoring system 100. Such usage patterns may also be utilized by business executives and management personnel (including, system administrators) to track the accessing of the system 100 by system users, to identify particular form contracts and groups of form contracts which are being often utilized or underutilized by system users, to determine which user departments are more actively using form contracts, and to ascertain whether the system's form contracts are merely being viewed or actually used by system users. Business executives and management personnel, based on such usage patterns, may also decide where encouragement is required to improve usage of the system 100.

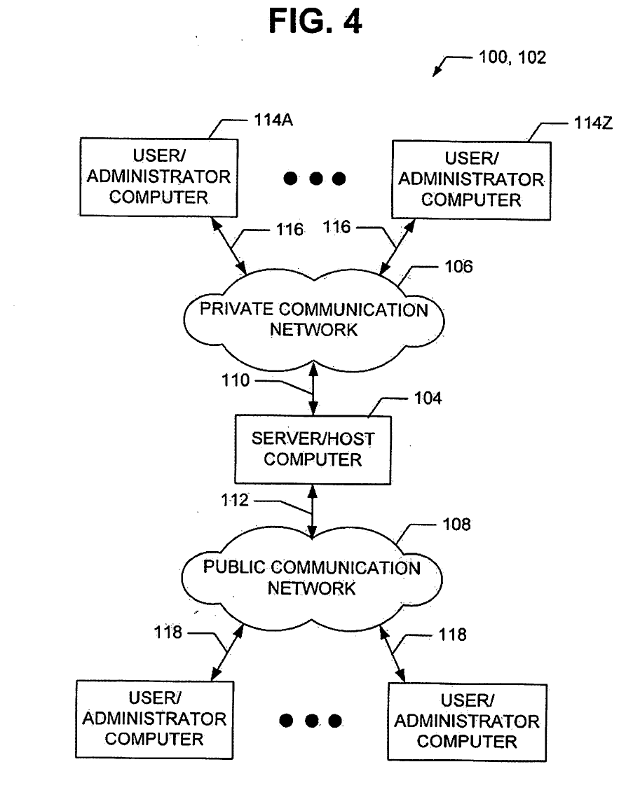

The form contract distribution and performance metrics monitoring system 100 (also sometimes referred to herein as the “contract forms database system”) comprises, according to the preferred embodiment, a computer hardware and software system having a computer hardware and data communication environment 102 and a computer software environment 202. FIG. 4 displays a block diagram representation of the computer hardware and data communication environment 102 which comprises a server/host computer 104 which is communicatively connected to a private communication network 106 and a public communication network 108 via bi-directional data communication links 110 and 112, respectively. Preferably, bi-directional data communication links 110, 112, acceptable in accordance with the preferred embodiment include, but are not limited to, T1 links, satellite links, and other present and future forms of, generally, high-speed, multi-channel, dedicated, cabled and non-cabled bi-directional data communication links.

The computer hardware and data communication environment 102 further comprises a plurality of user/administrator computers 114 (i.e., computers used by system users or by system administrators) communicatively connected to the private communication network 106 via bi-directional data communication links 116, and a plurality of user/administrator computers 118 communicatively connected to the public communication network 108 via bi-directional data communication links 120. Preferably, the private communication network 106 includes a bi-directional communication network which is accessible only to designated persons who are, typically, employees of a business that has implemented the form contract distribution and performance metrics monitoring system 100. The private communication network 106 may, or may not, also be accessible only through hard-wired bi-directional communication links and/or using user/administrator computers 114 at particular locations. Acceptable forms of the private communication network 106 include, but are not limited to, wide area communication networks (WANs), local area communication networks (LANs), and/or combinations thereof. Preferably, the public communication network 108 includes the Internet and the bi-directional data communication facilities of Internet service providers (not shown) necessary to enable bi-directional data communications between the server/host computer 104 and the user/administrator computers 118. Also, preferably, bi-directional data communication links 116, 120 include, but are not limited to, public switched telephone links, DSL links, broadband cable links, cellular links, satellite links, and other forms of bi-directional cabled and non-cabled, dedicated and non-dedicated data communication links available now or in the future. It should be understood that the scope of the present invention includes public communication networks other than the Internet which may be available now or in the future.

The server/host computer 104 hosts a plurality of software applications, modules, macros, and other programmatic components thereof having a plurality of software instructions which, when executed by the server/host computer 104, cause the server/host computer 104 to provide system users and system administrators using a user/administrator computer 114, 118 communicatively connected to the respective private or public communication networks 106, 108 and the server/host computer 104 with the various capabilities and functionality described herein. Preferably, such capabilities and functionality, in the case of a user/administrator computer 114 connected to the server/host computer 104 via a private communication network 106, are provided using a client/server data processing and communication model with the server/host computer 104 operating as a server computer and the user/administrator computer 114 operating as a client computer. In the case of a user/administrator computer 118 connected to the server/host computer 104 via a public communication network 108, such capabilities and functionality are, preferably, provided using a web host/browser data processing and communication model with the server/host computer 104 operating as a host computer and the user/administrator computer 118 operating as a browser computer. The general operation of computers and data communication hardware and software according to the client/server and web host/browser data processing and communication models is well known in the art and, therefore, it is not necessary to include a detailed discussion of such operation here. Although the present invention is described with respect to the client/server and web host/browser data processing and communication models, it should be understood that the scope of the present invention includes server/host computers and user/administrator computers which operate in accordance with other data processing and communication models which may be known now or become known in the future.

Preferably, the server/host computer 104 also includes hardware and other software or programmatic components (i.e., having software instructions executable by the server/host computer 104) appropriately configured to provide the capabilities and functionality described herein. In accordance with the preferred embodiment, the server/host computer 104 includes hardware and software appropriately configured to execute the server portion of the Lotus Notes® software program available from IBM® Corporation, and web hosting software available from Microsoft® Corporation. Further, an exemplary server/host computer 104 may include: one or more processing units for executing software program instructions; various forms of memory (including, for example and not limitation, random access memory, read-only memory and flash memory) for storing data and software program instructions; various forms of non-volatile program and data storage devices (including, but not limited to, magnetic disk drives, optical disk drives, magneto-optical disk drives, CD ROM drives, and DVD drives) for storing databases and database management software, web hosting software, data communication software, operating system software, software application programs and modules, configuration data, and other forms of data; various high and low speed data communication interfaces (including, for example and not limitation, T1 network interfaces, satellite network interfaces, wide area network interfaces, local area network interfaces, serial interfaces, and parallel interfaces) to enable the server/host computer 104 to bi-directionally communicate data via bi-directional communication links 110, 112 and with low speed devices; at least one display interface and video monitor; user input devices such as a keyboard and/or mouse; and, one or more buses to enable appropriate data communication between the foregoing components.

The user/administrator computers 114, 118 are, generally, possessed and operated by employees and system administrators. The user/administrator computers 114 include, generally, desktop or portable computer systems equipped with the client portion of the Lotus Notes® software program available from IBM® Corporation. The user/administrator computers 118 include, generally, desktop or portable computer systems equipped with Internet browser software which is operable to receive and display web pages and other data received from the server/host computer 104 and to receive and communicate user inputs from a keyboard or mouse to the server/host computer 104. Internet browser software, acceptable according to the preferred embodiment, includes Internet Explorer® software available from Microsoft® Corporation. Preferably, the user/administrator computers 114, 118 appropriately comprise: one or more processing units for executing software program instructions; various forms of memory (including, for example and not limitation, random access memory, read-only memory, and flash memory) for storing data and software program instructions; various forms of non-volatile program and data storage devices (including, but not limited to, magnetic disk drives, optical disk drives, magneto-optical drives, CD ROM drives, and DVD drives) for storing operating system software, application programs, Internet browser software, data communication software, client email communication software, configuration data, and other forms of data; various high and/or low speed data communication interfaces (including, for example and not limitation, DSL interfaces, broadband cable interfaces, cellular interfaces, satellite interfaces, local area network interfaces, serial interfaces, and parallel interfaces); at least one display interface and video monitor; user input devices such as a keyboard and/or mouse; and, one or more buses to enable appropriate data communication between the foregoing components.

It should be understood that the scope of the present invention includes user/administrator computers 114, 118 which are appropriately Lotus Notes® or Internet-enabled, but which do not necessarily comprise desktop or portable computer systems. For example and not limitation, user/administrator computers 114, 118 may include devices such as bi-directional communication-enabled PDAs (Personal Digital Assistants) and cellular telephones.

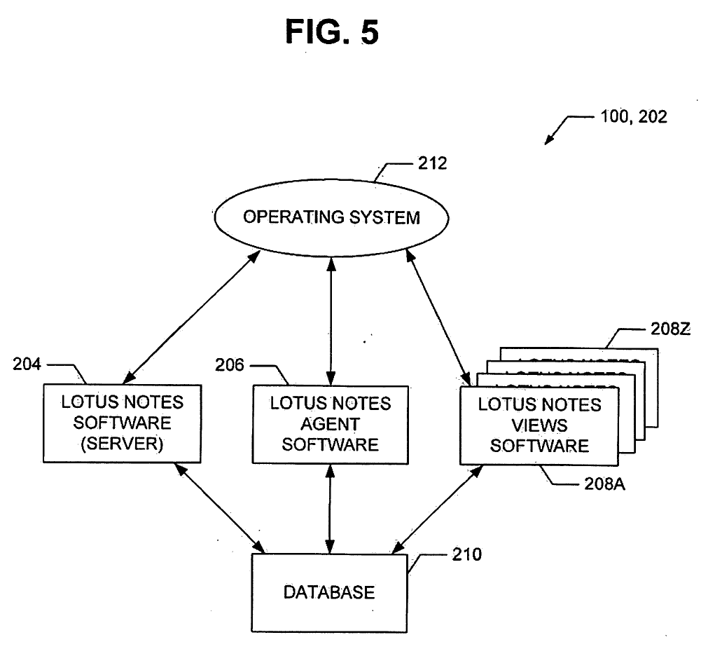

FIG. 5 displays a block diagram representation of the computer software environment 202 of the form contract distribution and performance metrics monitoring system 100, according to the preferred embodiment, which is present on the server/host computer 104. The computer software environment 202 comprises: the server portion of the Lotus Notes® software 204, a Lotus Notes® Agent software module 206, and a plurality of Lotus Notes® Views software modules 208 which, together, include software program instructions which, when executed by one or more processing units of the server/host computer 104, provide the capabilities, functionality, and features described herein using the communication links and communication networks of the computer hardware and data communication environment 102; a system database 210 (i.e., managed by the server portion of the Lotus Notes® software 204) for storing the data received, generated, and processed by the system 100, including without limitation, form contracts, contract profile data, performance metrics data, and user profile data (i.e., which includes information identifying each system user and the respective names of the departments in which the system users work); and, a virtual multi-tasking operating system 212 that includes software program instructions which, when executed by one or more processing units of the server/host computer 104, cause the server/host computer 104 to perform fundamental data processing operations necessary for operation of the server/host computer 104. The server portion of the Lotus Notes® software 204, Lotus Notes® Agent software module 206, plurality of Lotus Notes® Views software modules 208, and system database 210 each reside on a media of a data storage device of the server/host computer 104.

The server portion of the Lotus Notes® software 204, during operation, stores, retrieves, and updates form contracts, contract profile data, performance metrics data, and user profile data in the system database 210. Thus, for example, when a new or revised form contract is uploaded to the system database 210, the server portion of the Lotus Notes® software 204, upon execution, manages and performs all of the operations necessary to store the form contract in the database 210. Similarly, for example, the Lotus Notes® software 204 also performs all of the operations necessary to retrieve form contracts, contract profile data, performance metrics data, and user profile data, and to communicate the contracts and data to the client portion of the Lotus Notes® software executing on user/administrator computers 114, 118 for their presentation on the displays of the user/administrator computers 114, 118.

The Lotus Notes® Agent software module 206 is executed by the server/host computer 104 when a system user connects to or accesses the initial, or home page, of the form contract management and distribution system 100 via a private or public communication network 106, 108. Upon execution, the Lotus Notes® Agent software module 206 directs the server/host computer 104 to monitor actions performed by the system user and generate performance metrics data, based on those actions, which is stored in database 210. Thus, when a system user connects to the system 100, the Lotus Notes® Agent software module 206 causes the server/host computer 104 to create and store a document in database 210 having the user name of the system user that accessed the system 100, thereby “registering” a database hit. In addition to including the user name, the document includes the date (i.e., to enable subsequent data extraction and sorting by date) of the system access and a database hit counter field which is set to indicate that a database hit has occurred. If the system user opens a form contract for review, the Lotus Notes® Agent software module 206 causes the server/host computer 104 to “register” hits for the particular form contract reviewed, for the business group with which the form contract is associated, for the department of which the user is a member, and in the administrative metrics. Registration of these hits requires that the Lotus Notes® Agent software module 206 causes the server/host computer 104 to perform cross-referencing of contract and user profile data stored in database 210 to determine which business group the form contract is associated with and the department of the system user. Once cross-referencing is complete, the server/host computer 104 sets appropriate fields in the document to indicate which form contract was viewed by the system user, the business group associated with the form contract, and the department of the system user. In the event a system user launches, or downloads, a form contract, the Lotus Notes® Agent software module 206 also causes the server/host computer 104 to “register” a hit identifying the particular launched form contract and the business group with which the launched form contract is associated. To do so, the server/host computer 104 cross-references the contract profile data to determine the business group corresponding to the launched form contract and sets appropriate fields in the document to identify the launched form contract and the associated business group of the launched form contract.

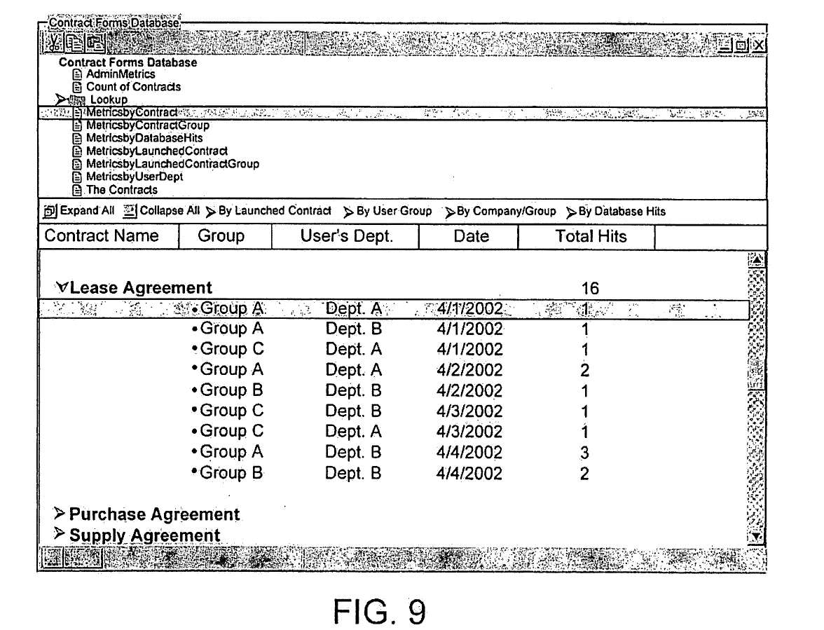

The plurality of Lotus Notes® Views software modules 208 are executed by the server/host computer 104 when a system administrator at a user/administrator computer 114, 118 desires to review performance metrics data generated and tracked by the system 100 in response to the actions of system users. Each Lotus Notes® Views software module 208 corresponds in one-to-one correspondence with a particular view of the performance metrics data stored in database 210. When execution of a Lotus Notes® Views software module 208 is initiated by a system administrator, the selected Lotus Notes® Views software module 208 causes the server/host computer 104 to perform a query on the performance metrics data present in system database 210 in order to extract appropriate data and to then format the extracted data in an appropriate view (e.g., including totals, sub-totals, and detailed information) for presentation to the requesting system administrator on his/her user/administrator computer 114, 118 (see FIGS. 9-15). Exemplary Lotus Notes® Views software modules 208 enable a system administrator to view performance metrics data by database hits, by contract, by contract group, by user department, by launched contract, and by launched contract group.

While not shown in a figure displaying a block diagram representation of the computer software environment of the user/administrator computers 114, 118 of the form contract distribution and performance metrics monitoring system 100, each user/administrator computer 114, 118 is configured with the client portion of the Lotus Notes® software and/or a web browser, either of which enable the user/administrator computer 114, 118 to interact with the system 100. In addition to allowing access to the form contracts and related contract profile data in system database 210, the client portion of the Lotus Notes® software and/or a web browser allows a system administrator to initiate a review of performance metrics data by selecting an option on the graphical user interface thereof (see the “View Metrics” button in FIG. 2 or 3). In response, the server/host computer 104 provides the system administrator's computer 114, 118 with viewing options for viewing the performance metrics data (i.e., by database hits, by contract, by contract group, by user department, by launched contract, and by launched contract group). Upon receiving the selection of a viewing option, the server/host computer 104 executes the appropriate Lotus Notes® Views software module 208 corresponding to the viewing option, thereby causing the extraction, formatting, and communication of the appropriate performance metrics data to the system administrator's computer 114, 118 for display thereon. Alternately, the Lotus Notes® Agent software module 206 and the Lotus Notes® Views software module 208, or software programming which performs substantially the same functions, may reside on the user/administrator computers 114, 118.

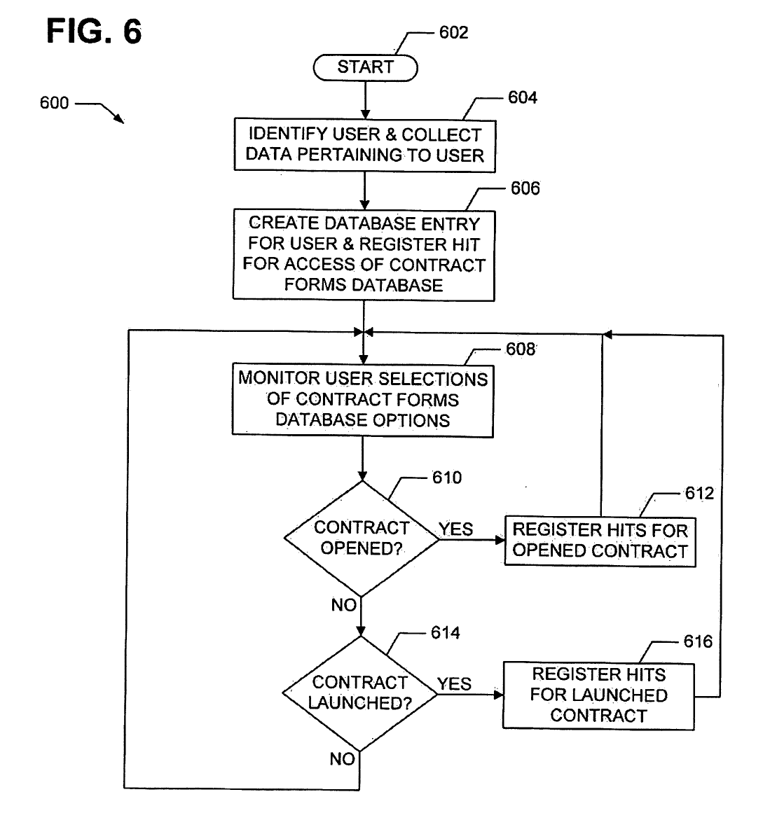

As described briefly above, the form contract distribution and performance metrics monitoring system 100 executes the software program instructions of the Lotus Notes® Agent software module 206 (i.e., in the background) in response to a system user accessing, or connecting to, the initial, or home page, of the form contract distribution and performance metrics monitoring system 100 via a private or public communication network 106, 108 in order to monitor and detect actions taken by system users and to generate performance metrics data corresponding to, and indicative or representative of, such actions. FIG. 6 displays a flowchart representation of the method of monitoring and performance metrics data generation 600 implemented by the Lotus Notes® Agent software module 206 in accordance with the preferred embodiment of the present invention. After starting at step 602, the method 600 advances to step 604 where the server/host 104 computer attempts to identify the system user accessing the system 100 and collects user profile data associated with the system user. If the system user has accessed the system 100 via the private communication network 106 using the client portion of the Lotus Notes® software residing on the user's computer 114 or via the public communication network 108 and correctly logging-in to the server portion of the Lotus Notes® software 204, the server/host computer 104, acting under the direction of the server portion of the Lotus Notes® software 204, uses the user's log-in information to retrieve the user profile data associated with the user in the system database 210. From the user profile data, the server/host computer 104 determines and retrieves the department with which the system user is associated, or works, and other information such as the user's email address. If the system user has accessed the system 100 via the public communication network 108 and has bypassed the log-in screen of the server portion of the Lotus Notes® software 204 (i.e., by linking directly to the home page of the system 100), the server/host computer 104 receives only an identification number corresponding to the user.

Continuing at step 606 of method 600, the server/host computer 104 creates a database entry in system database 210 for the user and registers a database hit, indicating and tracking the fact that the user has accessed the form contract distribution and performance metrics monitoring system 100. The database entry is in the form of a document created by the Lotus Notes® software 204 and stored in database 210. The server/host computer 104 includes information in the document identifying the system user (e.g., in the form of the user's user name or identification number, whichever is appropriate), the user's department, and, perhaps, the user's email address. The server/host computer 104 also includes the current date and sets a counter field to indicate that the user has accessed the system 100. Next, at step 608, the server/host computer 104 monitors inputs and/or selections of options made by the system user, via the user's computer 114, 118 and which are communicated to the server/host computer 104, to detect the occurrence of various actions taken by the user. One such action includes the selection and opening of a particular form contract for review from a list of form contracts displayed to the user on the user's computer 114, 118 (see FIG. 3) by the form contract distribution and performance metrics monitoring system 100. Another such action includes the selection and opening of a particular form contract for use (i.e., the user launches, or downloads, the form contract) from a list of form contracts displayed to the user on the user's computer 114, 118 (see FIG. 3) by the system 100.

Proceeding at step 610 of method 600, the server/host computer 104 analyzes a detected selection received at step 608 to determine if the action taken by the user corresponds to the selection and opening of a form contract for review. If so, the server/host computer 104 branches to step 612, where the server/host computer 104 registers a contract hit for the selected form contract by setting, or incrementing, a counter field for that form contract in the document created by the Lotus Notes® software 204 at step 606 described above. The server/host computer 104 also utilizes the contract profile data to determine the business group with which the selected form contract is associated and then registers a contract group hit by setting, or incrementing, a counter field for that business group (i.e., contract group) in the document created by the Lotus Notes® software 204 at step 606 described above. Additionally, the server/host computer 104, already knowing the department to which the user belongs, registers a user department hit by setting, or incrementing, a counter field for that user department in the document created at step 606. In addition, the server/host computer 104 registers an admin metrics hit by setting, or incrementing, counter fields for the current month and current year in the document created at step 606. After registering the admin metrics hit, the server/host computer 104 loops back to step 608 of method 600 to resume monitoring of selections or other actions taken by the user.

If, at step 610, the server/host computer 104 determines that the action taken by the user does not correspond to the opening of a form contract for review, then the server/host computer 104 advances to step 614 of method 600 to ascertain whether the action corresponds to the selection and launching of a form contract for downloading and use. If so, at step 616, the server/host computer 104 registers a launched contract hit by setting, or incrementing, a counter field for that form contract in the document created by the Lotus Notes® software 204 at step 606 described above. Also, the server/host computer utilizes the contract profile data to determine the business group with which the selected form contract is associated and then registers a launched contract group hit by setting, or incrementing, a counter field for that business group (i.e., contract group) in the document created by the Lotus Notes® software 204 at step 606 described above. Then, the server/host computer 104 loops back to step 608 of method 600 to resume monitoring of selections or other actions taken by the user. If the server/host computer 104 ascertains, at step 614, that the action taken by the user does not correspond to the selection and launching of a form contract, the server/host computer 104 loops back to resume monitoring at step 608 of method 600.

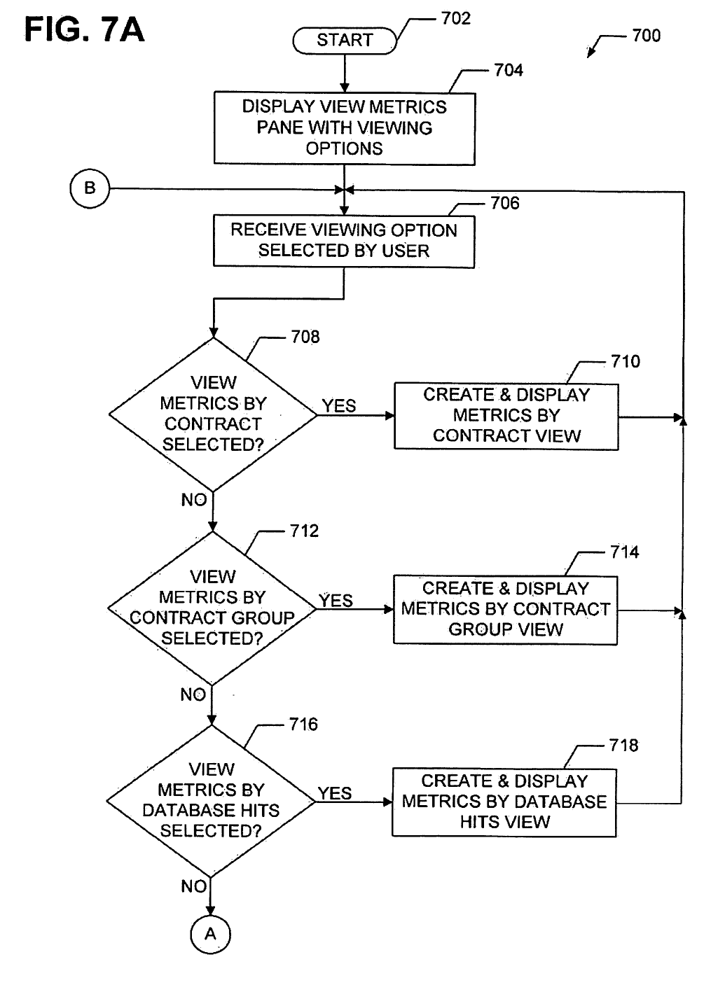

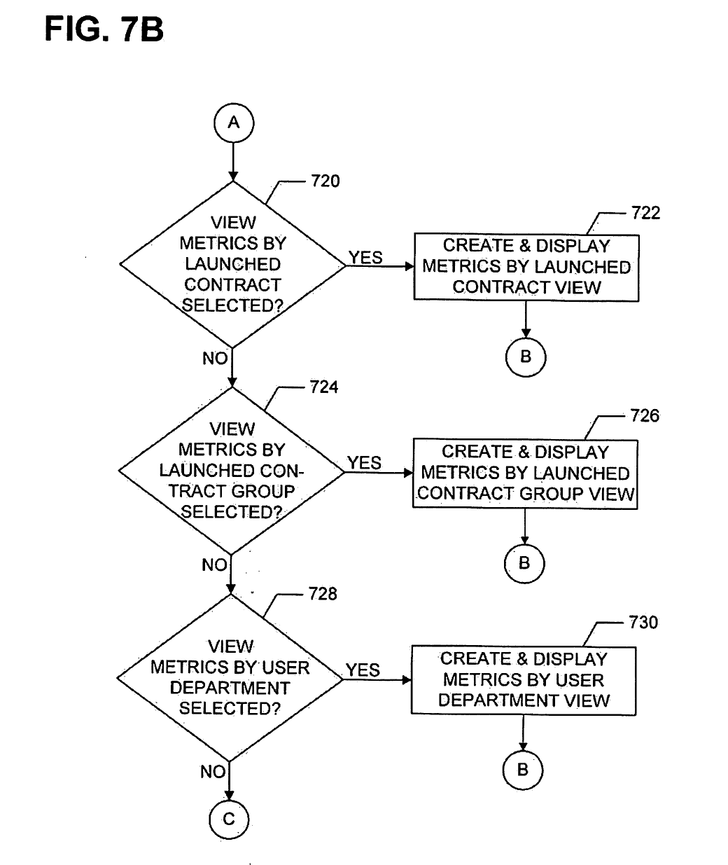

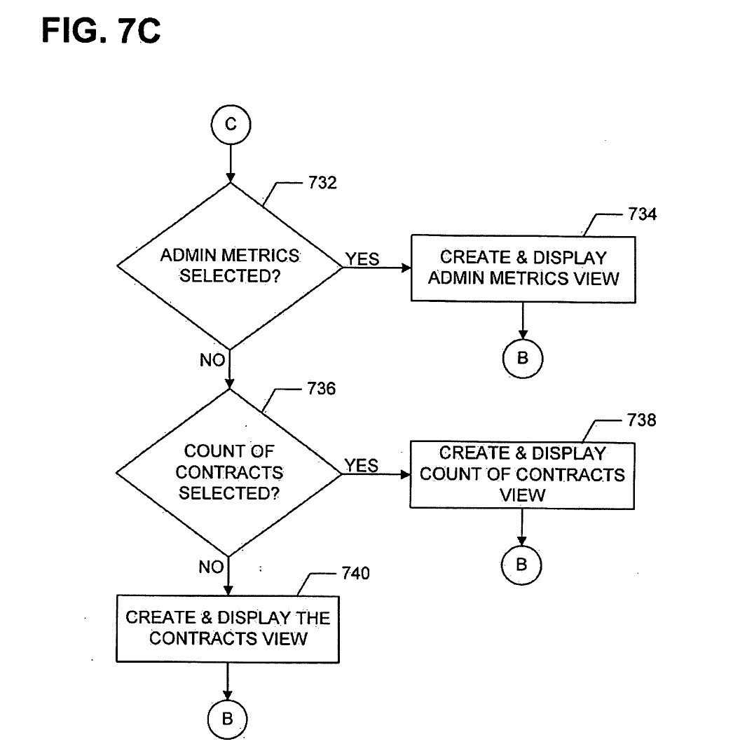

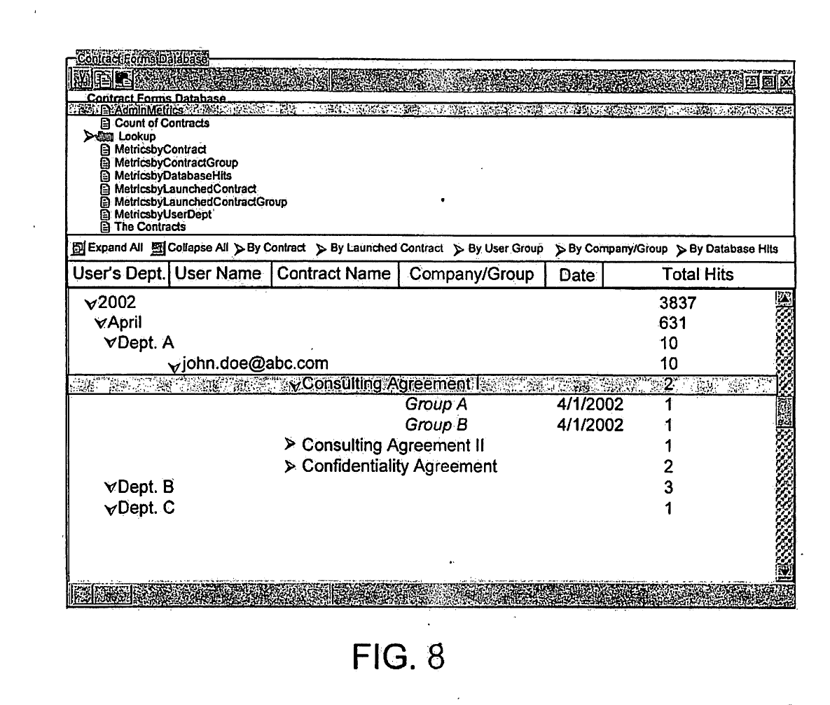

The form contract distribution and performance metrics monitoring system 100, as described briefly above, also provides system administrators with the ability to monitor and review the performance metrics data generated by the monitoring and performance metrics data generation method 600 (i.e., implemented by the Lotus Notes® Agent software module 206) in response to actions taken by system users. FIGS. 7A-7C display a flowchart representation of such a method of viewing performance metric data 700, according to the preferred embodiment, which is utilized by the form contract distribution and performance metrics monitoring system 100. After being started at step 702 in response to receiving a selection of a “view metrics” option by a system administrator from a screen of the system 100 (see FIG. 2 or 3), the method 700 advances to step 704 where the server/host computer 104 causes the display of a view metrics pane (see FIG. 8) on a system administrator's computer 114, 118. The view metrics pane includes viewing options selectable by the system administrator which enable the review of performance metrics data totaled, sub-totaled, organized, summarized, detailed, and sorted in a variety of different ways. For example and not limitation, such options include “Admin Metrics”, “Count of Contracts”, “Metrics by Contract”, Metrics by Contract Group”, “Metrics by Database Hits”, “Metrics by Launched Contract”, “Metrics by Launched Contract Group”, “Metrics by User Department”, and “The Contracts”. Then, at step 706, the server/host computer 104 awaits and receives a viewing option selection by the system administrator via the system administrator's computer 114, 118 and the appropriate communication network and data communication links.

Proceeding to step 708, the server/host computer 104 determines whether the selected option corresponds to the “Metrics by Contract” viewing option. If so, the server/host computer 104 branches to step 710 where it retrieves the documents created in system database 210, totals the number of times users opened form contracts for the year, sub-totals the number of times users opened form contracts for each month, and sub-totals the number of times users opened each form contract. Next, the server/host computer 104 performs any other necessary totaling, sub-totaling, organizing and formatting of contract hit performance metrics data, and causes the display of such data on the system administrator's computer 114, 118 as seen in FIG. 9, including the descriptive name of each form contract with the total number of times that users opened that form contract, and details for each form contract (including, the business (or contract) group with which each form contract is associated, the department of the user who opened the form contract, the date on which the form contract was opened, and the number of times the contract was opened on that date). Once such data is displayed on the system administrator's computer 114, 118, the server/host computer 104 loops back to step 706 of method 700 to again await the receipt of a viewing option selection by the system administrator.

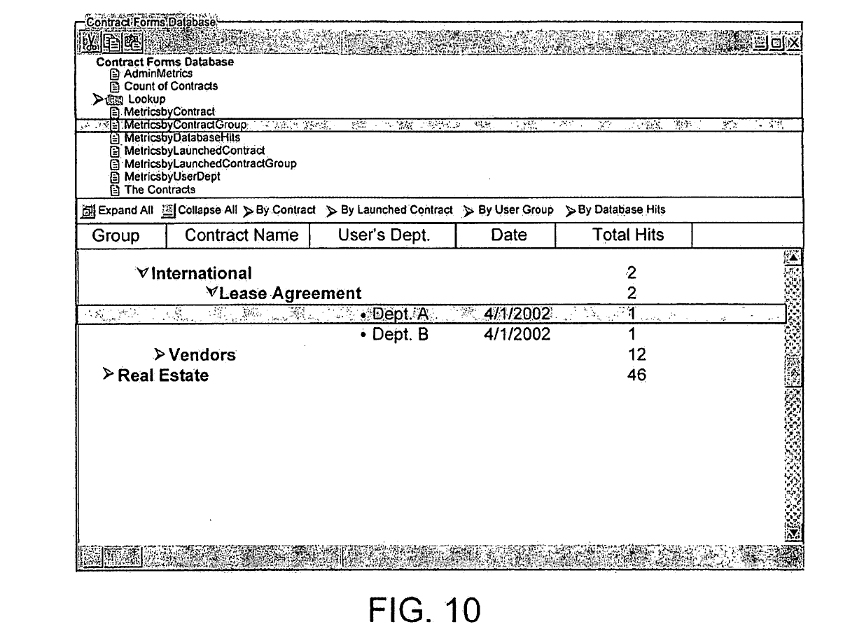

If, at step 708, the server/host computer 104 determines that the selected option does not correspond to the “Metrics by Contract” viewing option, the server/host computer 104 advances to step 712 where it ascertains whether the selected option corresponds to the “Metrics by Contract Group” viewing option. If so, the server/host computer 104 moves to step 714 of method 700 where it retrieves the documents created in system database 210, totals the number of times users opened form contracts for the year, sub-totals the number of times users opened form contracts for each month, and sub-totals the number of times users opened form contracts associated with each business (or contract) group. Then, the server/host computer 104 performs any other necessary totaling, sub-totaling, organizing and formatting of contract group hit performance metrics data, and causes the display of such data on the system administrator's computer 114, 118 as seen in FIG. 10, including the year and total of number of times users opened form contracts during the year, each month of the year and the sub-total of the number of times users opened form contracts during each respective month, the name of each business (or contract) group and the sub-total of the number of times users opened form contracts associated with each respective business (or contract) group, and details for each opened form contract associated with each respective business (or contract) group (including, the descriptive name of the form contract, the total number of contract hits for the form contract, and each date on which the form contract was opened with the name of the department of the user that opened the form contract and the number of contract hits). After causing the display of such data on the system administrator's computer 114, 118, the server/host computer 104 loops back to step 706 of method 700 to again await the receipt of a viewing option selection by the system administrator.

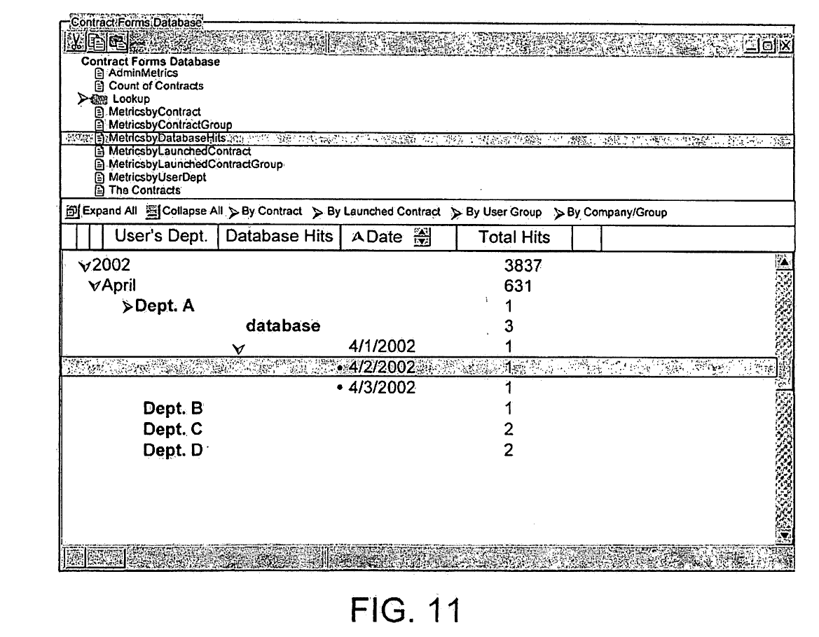

Upon ascertaining, at step 712, that the selected option does not correspond to the “Metrics by Contract Group” viewing option, the server/host computer 104 advances to step 716 where it decides whether the selected option corresponds to the “Metrics by Database Hits” viewing option. If so, the server/host computer 104 moves to step 718 of method 700 where it retrieves the documents created in system database 210, totals the number of times users accessed the system 100 for the year, sub-totals the number of times users accessed the system 100 in each month, and sub-totals the number of times users of each department accessed the system 100. The server/host computer 104 then performs any other necessary totaling, sub-totaling, organizing and formatting of database hit performance metrics data, and causes the display of such data on the system administrator's computer 114, 118 as seen in FIG. 11, including the year and total of number of times users accessed the system 100 for the year, each month of the year and the sub-total of the number of times users accessed the system 100 for each respective month, each department and the sub-total of the number of times users accessed the system 100 for each respective department, and details for each time users accessed the system 100 (including, the date of each access and the number of times the system 100 was accessed on those dates). Following the display of such data on the system administrator's computer 114, 118, the server/host computer 104 loops back to step 706 of method 700 to again await the receipt of a viewing option selection by the system administrator.

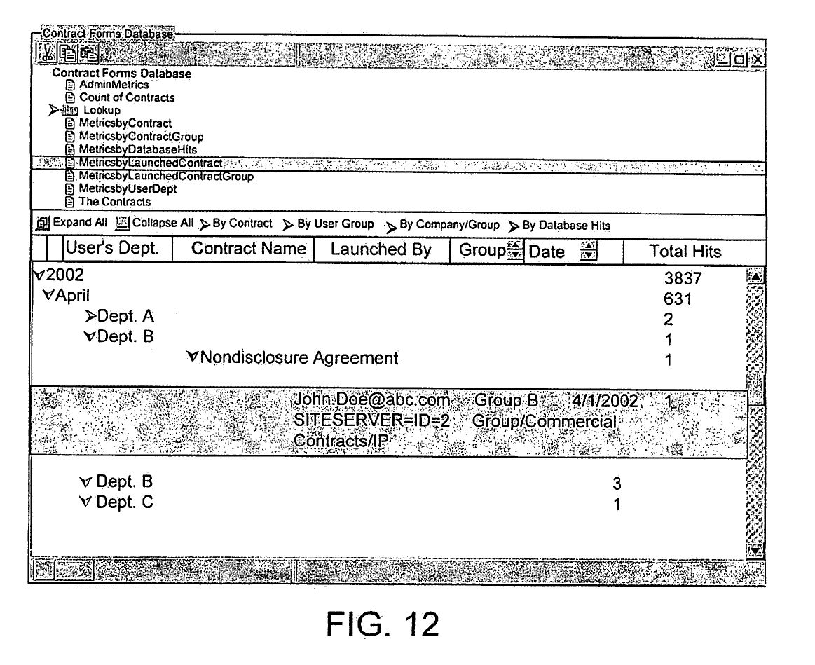

After deciding, at step 716, that the selected option does not correspond to the “Metrics by Database Hits” viewing option, the server/host computer 104 continues operation at step 720 of method 700 where it determines whether the selected option corresponds to the “Metrics by Launched Contract” viewing option. If so, the server/host computer 104 moves to step 722 of method 700 where it retrieves the documents created in system database 210, totals the number of times users launched form contracts for the year, sub-totals the number of times users launched form contracts for each month, and sub-totals the number of times users in each department launched form contracts. Next, the server/host computer 104 performs any other necessary totaling, sub-totaling, organizing and formatting of database hit performance metrics data, and causes the display of such data on the system administrator's computer 114, 118 as seen in FIG. 12, including the year and total of number of times users launched form contracts during the year, each month of the year and the sub-total of the number of times users launched form contracts during each respective month, each department name and the sub-total of the number of times users in each respective department launched form contracts, and details for each time users launched a form contract (including, the descriptive name of each launched form contract, and for each date on which a respective form contract was launched, information identifying the user who launched the form contract, the business group with which the launched form contract is associated, the launch date, and the number of times the user launched the form contract on each respective date). Once the server/host computer 104 causes the display of such performance metrics data on the system administrator's computer 114, 118, server/host computer 104 loops back to step 706 of method 700 to again await the receipt of a viewing option selection by the system administrator.

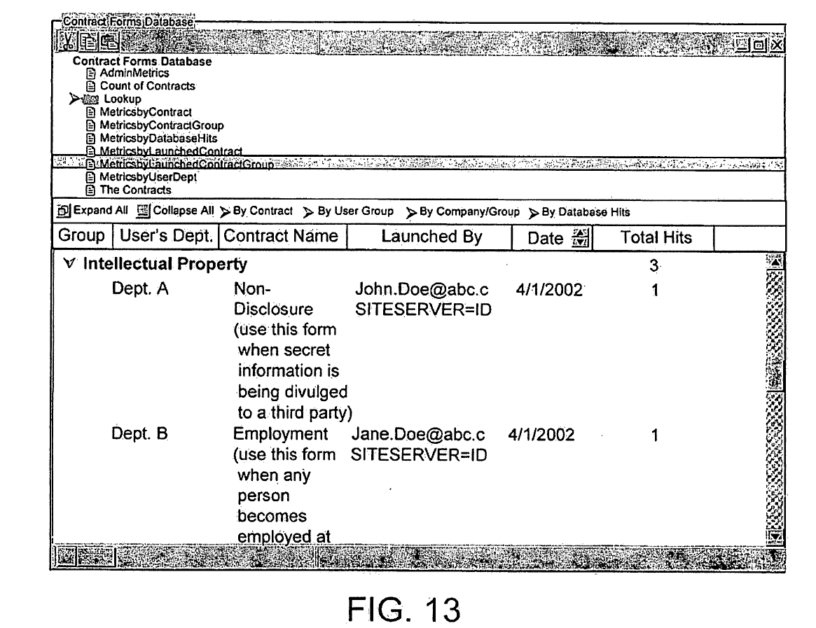

If, at step 720, the server/host computer 104 determines that the selected option does not correspond to the “Metrics by Launched Contracts” viewing option, the server/host computer 104 moves ahead to step 724 of method 700 where it ascertains whether the selected option corresponds to the “Metrics by Launched Contract Group” viewing option. If so, the server/host computer 104 advances to step 726 of method 700 where it retrieves the documents created in system database 210, totals the number of times users launched form contracts for the year, sub-totals the number of times users launched form contracts for each month, and sub-totals the number of times that form contracts associated with each business (or contract) group were launched by users. Then, the server/host computer 104 performs any other necessary totaling, sub-totaling, organizing and formatting of database hit performance metrics data, and causes the display of such data on the system administrator's computer 114, 118 as seen in FIG. 13, including the year and total of number of times users launched form contracts during the year, each month of the year and the sub-total of the number of times users launched form contracts during each respective month, the name of each business (or contract) group and the sub-total of the number of times form contracts associated with each respective business (or contract) group were launched by users, and details for each time users launched a form contract (including, the name of the department of the user who launched a form contract, the descriptive name of the launched form contract, information identifying the user who launched the form contract, the date on which the form contract was launched, and the number of times the user launched the form contract on that respective date). Once the server/host computer 104 causes the display of such performance metrics data on the system administrator's computer 114, 118, server/host computer 104 loops back to step 706 of method 700 to again await the receipt of a viewing option selection by the system administrator.

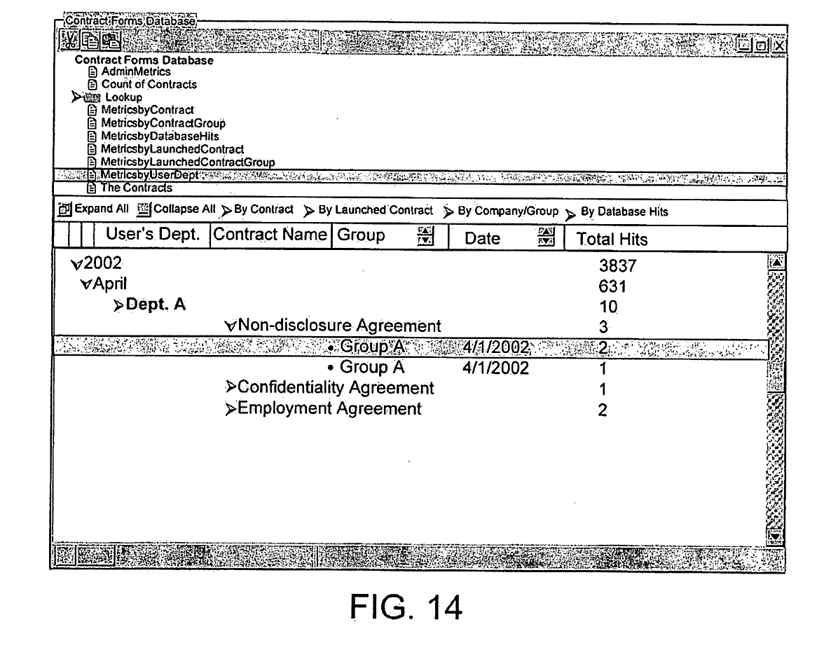

Upon ascertaining, at step 724, that the selected option does not correspond to the “Metrics by Launched Contract Group” viewing option, the server/host computer 104 advances to step 728 where it decides whether the selected option corresponds to the “Metrics by User Department” viewing option. If so, the server/host computer 104 moves to step 730 of method 700 where it retrieves the documents created in system database 210, totals the number of times users opened form contracts for the year, sub-totals the number of times users opened form contracts for each month, and sub-totals the number of times users in each department opened form contracts. Next, the server/host computer 104 performs any other necessary totaling, sub-totaling, organizing and formatting of user department hit performance metrics data, and causes the display of such data on the system administrator's computer 114, 118 as seen in FIG. 14, including the descriptive name of each user department with the total number of times that users in each respective department opened form contracts, and details for each form contract (including, the descriptive name of each form contract and the number of times that users opened each respective form contract, the name of the business (or contract) group with which each form contract is associated, the date on which the form contract was opened, and the number of times the contract was opened on that date). Once such data is displayed on the system administrator's computer 114, 118, the server/host computer 104 loops back to step 706 of method 700 to again await the receipt of a viewing option selection by the system administrator.

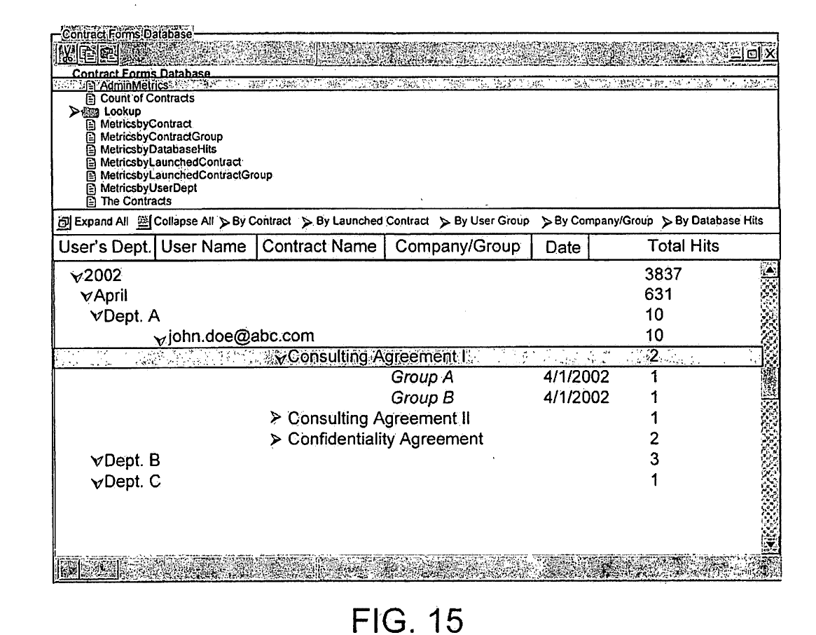

After deciding, at step 728, that the selected option does not correspond to the “Metrics by User Department” viewing option, the server/host computer 104 continues operation at step 732 of method 700 where it determines whether the selected option corresponds to the “Admin Metrics” viewing option. If so, the server/host computer 104 moves to step 734 of method 700 where it retrieves the documents created in system database 210, totals the number of times users opened form contracts for the year, sub-totals the number of times users opened form contracts for each month, and sub-totals the number of times users in each department launched form contracts. Next, the server/host computer 104 performs any other necessary totaling, sub-totaling, organizing and formatting of database hit performance metrics data, and causes the display of such data on the system administrator's computer 114, 118 as seen in FIG. 15, including the year and total of number of times users opened form contracts during the year, each month of the year and the sub-total of the number of times users opened form contracts during each respective month, each department name and the sub-total of the number of times users in each respective department opened form contracts, and details for each time users opened a form contract (including, information identifying the user and the number of times that user opened a form contract, and for each user who opened a form contract, the descriptive name of each form contract opened by the user, the business (or contract) group with which the opened form contract is associated, the date on which the user opened the form contract, and the number of times the user opened the form contract on each respective date). Once the server/host computer 104 causes the display of such performance metrics data on the system administrator's computer 114, 118, the server/host computer 104 loops back to step 706 of method 700 to again await the receipt of a viewing option selection by the system administrator.

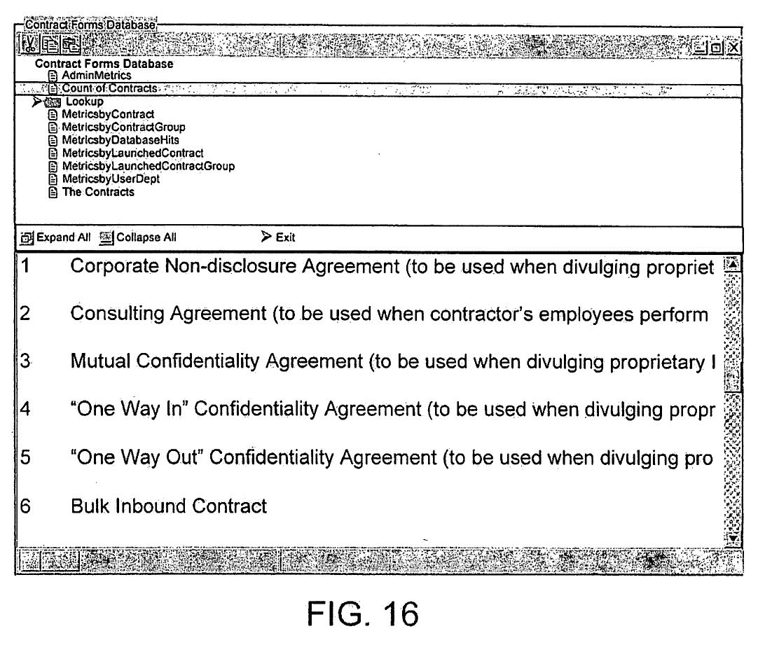

If, at step 732, the server/host computer determines that the selected option does not correspond to the “Admin Metrics” viewing option, the server/host computer 104 continues operation at step 736 of method 700 where it ascertains whether the selected option corresponds to the “Count of Contracts” viewing option. If so, the server/host computer 104 moves to step 738 of method 700 where it retrieves a list of the form contracts present in the system 100 and causes the display of such list on the system administrator's computer 114, 118 as seen in FIG. 16, including, for each form contract, a counter indicating the form contract number and the descriptive name of the form contract. After causing the display of such information on the system administrator's computer 114, 118, the server/host computer 104 loops back to step 706 of method 700 to again await the receipt of a viewing option selection by the system administrator.

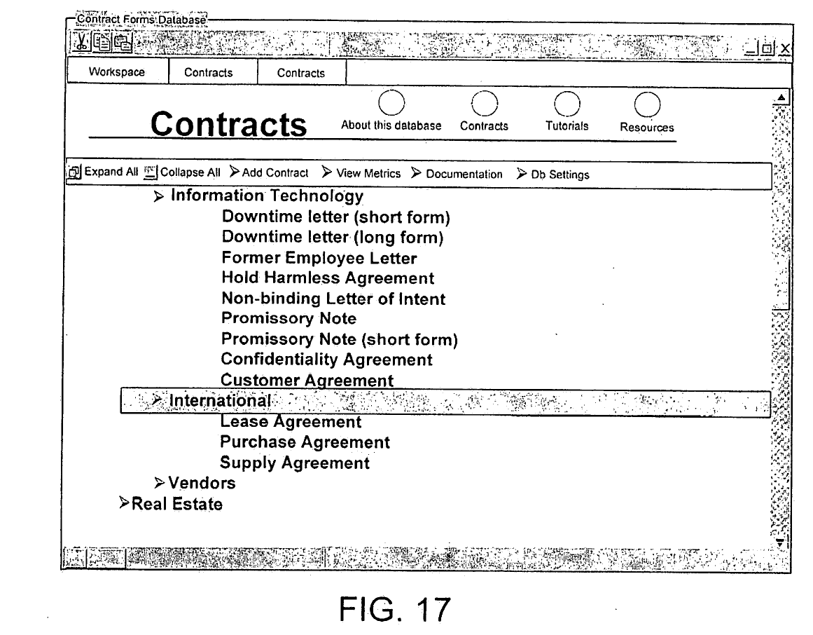

If the server/host computer 104 ascertains, at step 736, that the selected option does not correspond to the “Count of Contracts” viewing option, the server/host computer 104 advances to step 740 where it retrieves a list of the form contracts present in the system 100 and causes the display of such list on the system administrator's computer 114, 118 as seen in FIG. 17, including, for each form contract, the descriptive name of the form contract. The system administrator, if desired, may view the form contracts by selecting them from the list. Once the server/host computer 104 causes the display of the list of form contracts on the system administrator's computer 114, 118, the server/host computer 104 loops back to step 706 of method 700 to again await the receipt of a viewing option selection by the system administrator.

It should be understood that the system of the present invention may be implemented without using the Lotus computer software identified herein. Instead, in an alternate embodiment, appropriate other computer software programs may be customized or written to provide the features and capabilities described herein. Further, various database managers may be utilized to provide the requisite database storage and retrieval functionality.

Whereas this invention has been described in detail with particular reference to its most preferred embodiments, it is understood that variations and modifications can be effected within the spirit and scope of the invention, as described herein before and as defined in the appended claims. The corresponding structures, materials, acts, and equivalents of all means plus function elements, if any, in the claims below are intended to include any structure, material, or acts for performing the functions in combination with other claimed elements as specifically claimed.

What is claimed is:

1. A method of distributing and monitoring use of electronically stored documents comprising:
electronically storing a plurality of editable form documents in a forms database;
providing access, via a bi-directional communications network, to users of said forms database;
enabling each user who has obtained access to said database to view a directory of stored form documents;
enabling each said user to select and view at least one of said stored form documents from said directory;
enabling said user to edit and retrieve an edited version or an unedited version of said document selected from said directory; and
identifying and storing information regarding actions taken by each user in connection with said database.

2. A method according to claim 1 and further comprising:
enabling system monitor ones of said users to access said stored information regarding actions and to compile data regarding said actions.

3. A method according to claim 1 wherein:
upon providing access by a user to said forms database, registering a hit when said user takes an action with respect to said database.

4. A method according to claim 3 wherein:
upon providing access by a user to said forms database, registering and storing a database hit.

5. A method according to claim 4 wherein:
upon registering a database hit, storing the identity of the user accessing said database.

6. A method according to claim 5 wherein:
upon registering a database hit, storing the identity of the data of said database hit.

7. A method according to claim 6 wherein:
upon enabling said user to select said at least one of said stored documents, registering a hit for the particular document selected.

8. A method according to claim 7 wherein:
upon registering a hit for a particular document selected, registering a hit for a particular group with which the particular document is associated.

9. A method according to claim 7 wherein:
upon enabling said user to select said at least one of said stored documents, registering a hit for a particular organization with which said user is associated.

10. A method according to claim 9 wherein:
upon enabling a user to select and view a stored document, cross-referencing user and document data.

11. A method according to claim 10 wherein:
upon enabling a user to retrieve a version of a document selected from said directory, recording a download hit for said document.

12. A method according to claim 8 wherein:
each of said stored documents comprises a form contract associated with particular operational groups within a business organization; and
said database further comprises explanatory information relating to alternative provisions for said contracts.

13. A method of electronically storing, distributing and monitoring use of electronically editable documents comprising form contracts according to claim 1 and further comprising:
identifying and storing the identity of each user who obtains access to said database.

14. A method according to claim 13 and further comprising:
storing a first indicator with respect to each form contract each time it is viewed by a user.

15. A method according to claim 14 and further comprising:
storing a second indicator with respect to each form contract each time it is downloaded by a user.

16. A method according to claim 15 and further comprising:
storing a third indicator with respect to each form contract each time it is used by a user associated with a particular group.

17. A method according to claim 1 wherein:
each of said stored documents comprises a form contract associated with particular operational groups within a business organization; and
said database further comprises explanatory information relating to alternative provisions for said contracts.

18. A method according to claim 17 and further comprising:
enabling system monitor ones of said users to access said stored information regarding actions and to compile data regarding said actions.

19. A method according to claim 18 and further comprising:
enabling said system monitor users to retrieve reports of said actions.
